(19) United States
(12) Patent Application Publication
(10) Pub. No.: US 2003/0003956 A1
(43) Pub. Date: Jan. 2, 2003

(54) Complementing a portable telecommunication device with notepad capability

(76) Inventors: Tarmo Maenpaa, Salo (FI); Heikki Kasurinen, Inkere (FI); Marjukka Joutsen, Halikko (FI)

Correspondence Address: PERMAN & GREEN, 425 POST ROAD, FAIRFIELD, CT, 06824, US

(21) Appl. No.: 10/187,713

(22) Filed: Jul. 1, 2002

(30) Foreign Application Priority Data
Jul. 2, 2001 (FI) 20011430

(51) Int. Cl. H04B 1/38

(52) U.S. Cl. 455/556; 455/66; 455/567

(57) ABSTRACT

A portable telecommunications device (101, 702) comprises a rewritable notepad (102, 606, 702). The rewritable notepad can be built as a part of the portable telecommunications device (101, 702), as a part of an exchangeable cover (504) for a portable telecommunications device or as a part of an attachable accessory (600). The rewritable notepad (102, 606, 702) can be for example a magnetic migration display panel, a chalkboard or a whiteboard.

### TECHNICAL FIELD

The invention concerns generally the technology of enhancing the everyday usability of mobile telecommunication devices. Especially the invention concerns the technology of enabling the user of a mobile telecommunication device to make notes.

### BACKGROUND OF THE INVENTION

Despite of the introduction of devices like laptop computers with cellular phone capability, or the Nokia Communicators (the 9000 series) manufactured and marketed worldwide by Nokia Mobile Phones Ltd., by far the most popular form of a mobile telecommunication device is (and is likely to remain for quite some time) the conventional mobile telephone. “Conventional” means here that the device fits nicely to the palm of a human user and is equipped with integrated microphone and loudspeaker, so in a normal operational position a user holds the device by one hand on one side of his head against the ear and cheek area.

It is not rare that a person speaking to his mobile phone has to make notes in the middle of the phone call. For example, during the call he may hear the name and address of a person to be contacted or some other information that should be exactly remembered. Episodes that are amusing to everyone else but embarrassing to the person himself are to be seen when one tries to balance a miniature-sized mobile telephone against one shoulder while using both hands to scribble a note. The difficulty of making notes in the middle of a phone call is clearly a common everyday problem that cries for an effective solution.

Multifunctional communication devices exist that allow the user to use the device's own keyboard and display during a call. A prominent example is the above-mentioned Nokia Communicator family that allows the user to open the clamshell cover of the device, place the opened device on a table or in the lap and use the large LCD display and full alphanumeric keyboard thus exposed for any required purposes even in the middle of a call. An intelligent integrated hands-free function reacts to opening the cover by adapting the loudspeaker function and microphone sensitivity so that communication may continue normally despite of the device now being much farther from the mouth and ear of the user. The drawbacks of this approach are related to the electromechanical complicatedness of the device. Even in very conventional mobile telephones the user has the possibility of using the small numerical keypad and the LCD display without interrupting a call. Such a basic approach has the drawback that only limited kinds of information, mainly short alphanumeric sequences, can be written down.

As a further developed version of said conventional mobile telephones there exist mobile telecommunication devices that are equipped with a touch-sensitive writing area that can even be (at least partly) sandwiched together with an LCD screen to constitute a touch-sensitive display. The user uses a pointer pen or some other relatively sharp object to input information through the touch-sensitive writing area. Very few limitations are posed to the kinds of information that can be input this way, but touch-sensitive screens tend to be relatively expensive and are known to cause certain reliability problems in longer use and under difficult operating conditions.

### SUMMARY OF THE INVENTION

It is an object of the invention to provide an inexpensive and easy-to-use solution to the problem of making notes while using a portable telecommunications device. It is another object of the invention that the solution should be applicable to a wide variety of different kinds of portable telecommunications devices. A yet further object of the invention is that relief should be provided to the note-making problems of even users that already have a mobile telephone and are not immediately willing to acquire a new one just to reap the benefits of the present invention.

The objects of the invention are achieved by providing a rewritable notepad to be attached to or manufactured as a part of a portable telecommunications device or the outer cover thereof.

A portable telecommunications device according to the invention is characterized by the features recited in the independent patent claim directed to a portable telecommunications device.

The invention applies also to an exchangeable cover part of a portable telecommunications device. The exchangeable cover part according to the invention is characterized by the features recited in the independent patent claim directed to an exchangeable cover part.

Additionally the invention applies to an accessory for a portable telecommunications device. The accessory for a portable telecommunications device according to the invention is characterized by the features recited in the independent patent claim directed to an accessory for a portable telecommunications device.

A rewritable notepad is a general term that covers all kinds of essentially solid surfaces onto which semi-permanent markings can be made with a suitable marking instrument. An important difference between rewritable notepads and touch-sensitive screens or displays is that on a rewritable notepad the markings become visible directly through essentially mechanical action, while touch-sensitive screens and displays require intermediate electronic measures like detecting and localizing a touch, converting the detected and localized touch into location information with respect to the dimensions of the touch-sensitive display, and driving a display element, the location of which corresponds to the detected location, to exhibit a visual characteristic that constitutes a “trace” of the touch. Rewritable notepad types that are known as such as e.g. magnetic migration display panels, chalkboards and the so-called whiteboards that are plastic surfaces from which certain types of instantly drying inks wipe off very easily.

Magnetic migration display panels are regarded to constitute the most advantageous form of rewritable notepads to be used according to the invention for various reasons. The writing instrument used to make notes on a magnetic migration display panel is a magnetic pen that does not foul, dry out or wear out and is easy to produce in a small enough size to be easily carried along with a portable telecommunications device. Erasing a magnetic migration display panel is simple and fast and can be accomplished with an integrated eraser bar that can not be lost and is not easily damaged. Magnetic migration display panels are relatively thin, and their manufacturing costs are low. They require little or no maintenance at all, and they can be manufactured as integrated parts of portable telecommunications devices, as integrated parts of exchangeable covers for portable telecommunications devices, or even as add-ons to existing portable telecommunications devices or their covers.

Many of the above-mentioned advantageous features also apply to other kinds of rewritable notepads, but for example all solutions that require some marking substance like chalk or ink to be physically transferred from the marking instrument to the notepad surface tend to be vulnerable to wearing out of the marking substance or fouling.

### BRIEF DESCRIPTION OF DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates schematically the principle of the invention,

FIG. 2 illustrates a magnetic migration display panel integrated into the cover of a device,

FIG. 3 illustrates another way of integrating a magnetic migration display panel into the cover of a device,

FIG. 4 illustrates yet another way of integrating a magnetic migration display panel into the cover of a device,

FIG. 5 illustrates a series of exchangeable telephone covers one of which is equipped with a rewritable notepad,

FIG. 6 illustrates a rewritable notepad as an add-on to an existing mobile telecommunications device and

FIG. 7 illustrates a rewritable notepad on the front side of a mobile telephone.

### DETAILED DESCRIPTION OF THE INVENTION

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The concept of a rewritable notepad is known as such. In this patent application we treat especially one specific kind of a rewritable notepad, but this should be regarded only as an example of the invention's applicability so that other kinds of rewritable notepads are not completely excluded.

The specific kind of a rewritable notepad to be discussed is a magnetic migration display panel. The definition refers to a structure where a magnetic pointer (also known as a magnetic pen) can be used to locally arrange certain magnetic particles so that the contrast in color between the arranged magnetic particles and some surrounding substance results in a visible image. In a construction known for example from the prior art publication number EP-A-1 013 323 and the publications referred to therein, two parallel planar substrates define a relatively narrow space therebetween. A multi-cell structure including a plurality of cells fills said narrow space. The cells contain a dispersion, which includes magnetic particles, a dispersion medium and a coloring agent constituting a background. Thickening agents can be used to obtain a required viscosity for the dispersion. When a magnetic pen comes close enough to the surface of the first substrate, the magnetic particles get attracted by the magnetic force and migrate through the dispersion to an inner surface of the transparent or translucent front-side substrate. The result is a monochromatic visual effect that comes from a difference in color between the “clear” dispersion and the magnetic particles contained therein.

Typically a magnetic migration display panel comes with an integrated eraser bar, which is an elongated magnetic element supported at both ends by a sliding arrangement that allows the eraser bar to be slid immediately behind the magnetic migration display panel across its whole area. Also other kinds of supporting arrangements are known. The construction of the supporting arrangement or the physical form of the eraser are not important as long as they allow a magnetic element to be easily brought into a temporary close contact with essentially every point of the back side of the magnetic migration display panel. The appearance of a magnet behind a certain cell in the magnetic migration display panel causes the magnetic particles within the dispersion contained in the cell to be attracted towards the back-side substrate, leaving only “clear” substrate visible on the inner surface of the transparent or translucent front-side substrate. It is even possible to erase a magnetic migration display panel electrically, if the back-side substrate is equipped with a dense enough array of controllable electromagnets. Conducting an electric current through such electromagnets induces a magnetic force that has exactly the same effect as sliding an eraser bar across the back side of the magnetic migration display panel.

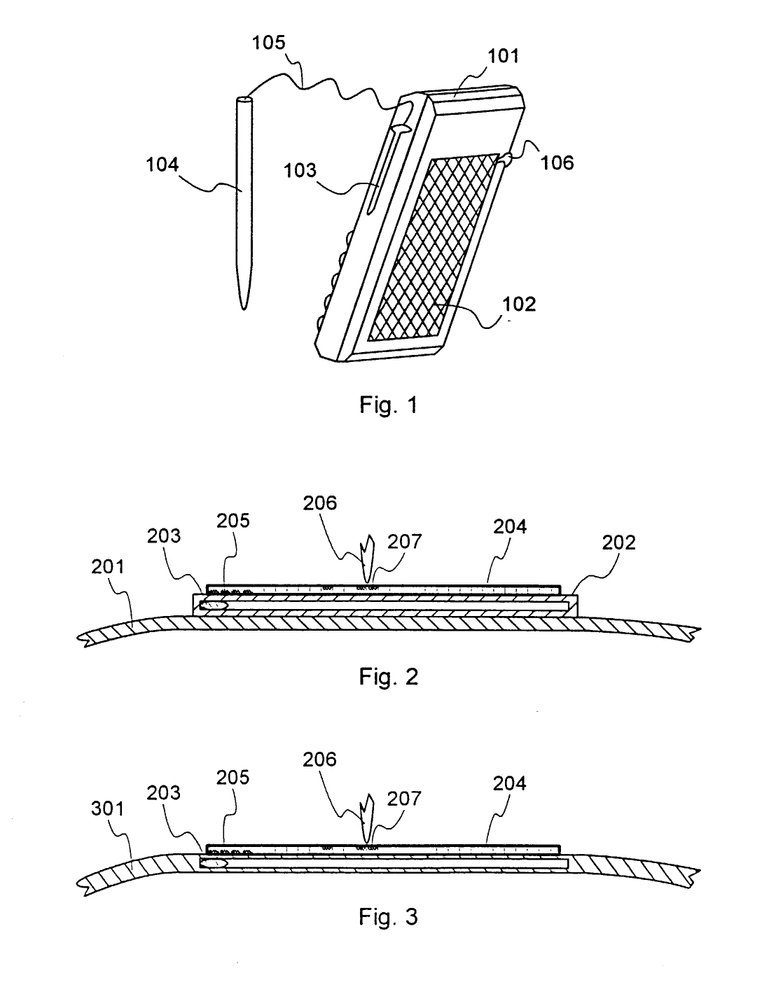

FIG. 1 illustrates schematically a mobile telecommunications device 101, which in this example is a mobile telephone. At some location on the outer surface of the mobile telecommunications device 101 there is located a rewritable notepad 102. In this exemplary embodiment the rewritable notepad 102 is located on the back side of the mobile telecommunications device 101 for the simple reason that the back side is usually the one to have most free space available on the outer surface of the cover of a mobile telephone. The actual location of the rewritable notepad in relation to the other physical characteristics of the mobile telecommunications device is unimportant to the invention.

In order to facilitate instant usability of the rewritable notepad 102 the cover of the mobile telecommunications device 101 defines a holder 103 for carrying a writing instrument 104. Most advantageously the holder 103 is a slot that comprises some kind of mechanical attachment means for the writing instrument that keep it from accidentally falling off. Holders for writing instruments are known from e.g. those various stylus-controlled personal digital assistant devices that are on the market at the priority date of this patent application. The writing instrument 104 may be secured to the body of the mobile telecommunications device 101 with a self-retracting cord 105 or the like, but this is not necessary and may even prove to be cumbersome in practical use.

Further in order to facilitate instant re-usability of the rewritable notepad 102 there should be provided some kind of erasing means. In the schematic drawing of FIG. 1 we assume that the erasing means consist of an integrated erasing bar 106 that can be slid across the underside of the rewritable notepad 102. Only one end of the erasing bar 106 is visible in FIG. 1 because the rest of the erasing bar extends under the rewritable notepad 102. The erasing means could also comprise a sponge, a rubber eraser or a similar erasing instrument that is either integrated into a single mechanical unit with the writing instrument 104 or coexistent therewith. In the latter case there should preferably be provided a holder for the erasing means too in similar fashion as the holder 103 for the writing instrument 104.

FIG. 2 is a schematic partial cutout diagram through a cover part 201 of a portable telecommunications device. A frame 202 is attached to an outer side of the cover part 201. The frame defines an internal gap in which an erasing bar 203 can be slid back and forth in the direction that in FIG. 2 is horizontal. A cell plate 204 consisting of inner and outer planar substrates and a cellular structure therebetween is attached to the outer side of the frame 202. At least the outer substrate of the cell plate 204 is transparent or translucent to visible light. The cells of said cellular structure contain magnetic particles embedded in a relatively thick dispersion that keeps the magnetic particles from moving freely under the influence of forces that are in the order of the normal gravity of Earth. For reasons of graphical clarity FIG. 2 only illustrates the magnetic particle content of some of the cells. The dispersion is opaque, and the color of the dispersion differs strongly from the color of the magnetic particles. Near the erasing bar 203, in the cells exemplary designated as 205, the magnetic particles are attracted by the magnetic attraction power of the erasing bar 203 and driven against the inner substrate of the cell plate 204. If a magnetic pointer pen 206 or any other magnetic object is brought close to the outer substrate of the cell plate 204, the magnetic particles in the cells 207 at the touching point migrate against the outer substrate, thus constituting a trace that is visible from the outside.

FIG. 3 illustrates schematically an alternative to the structure of FIG. 2. Here no frames are needed to support the erasing bar 203, because the cover 301 of the portable telecommunications device has been designed to define an internal gap where the erasing bar 203 can be slid back and forth in the direction that in FIG. 3 is horizontal. The cell plate 204 is now attached directly to the outer surface of the cover 301 of the portable telecommunications device. The structure and operation of parts 203, 204, 205, 206 and 207 is the same as in FIG. 2.

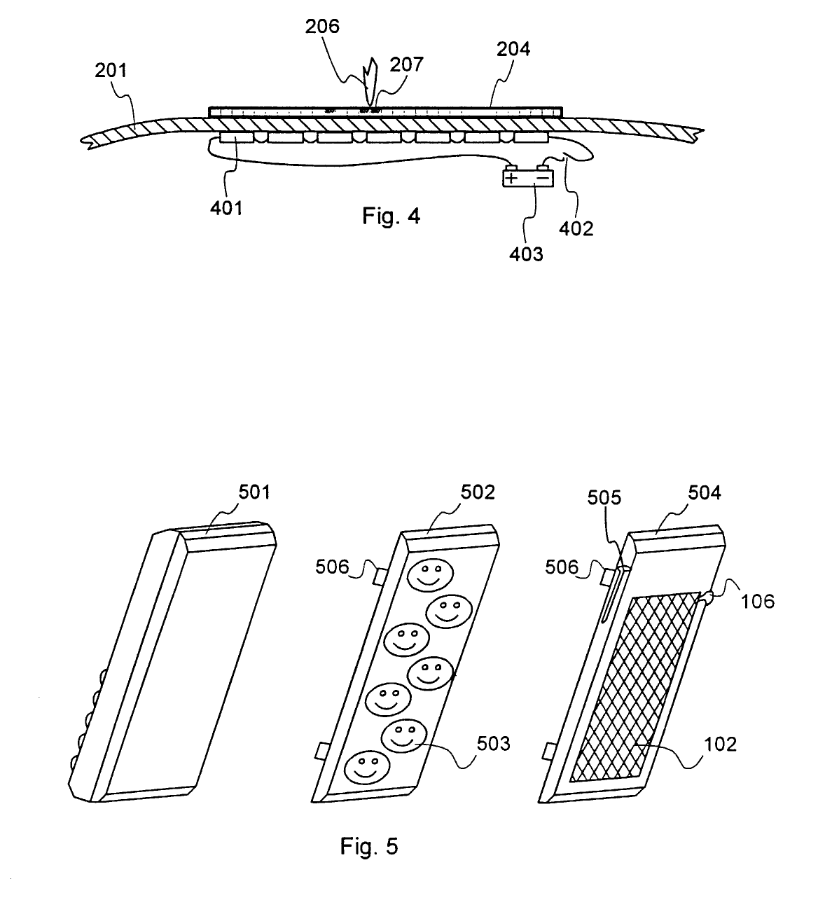

FIG. 4 illustrates schematically another alternative to the structures of FIGS. 2 and 3. Here again no frames are needed, because neither are there any erasing bars. Instead, the cover 201 of the portable telecommunications device comprises, on an inner side thereof, an array of electromagnets 401 coupled through a controllable switch 402 to a source 403 of electric current, which typically is the main battery of the portable electronic device. Closing the switch 402 causes an electric current to flow from the current source 403 through the electromagnets 401, which induces a magnetic attraction power that draws the magnetic particles in the cells of the cell plate 204 against the inner substrate of the cell plate, thus erasing any visible traces 207 of the magnetic pointer pen 206. The erasing switch 402 may be a switch for itself in the assembly constituted by the portable telecommunications device and the rewritable notepad, or the switching function may be associated with some control command that a user can give through the conventional user interface of the portable telecommunications device.

FIG. 5 illustrates schematically a series of exchangeable cover parts for a portable telecommunications device. User-exchangeable cover parts for portable telecommunications devices are manufactured and marketed worldwide at the priority date of this patent application e.g. under the registered trade mark “Xpress-on” by Nokia Mobile Phones Ltd. Exchangeable cover parts that require a trained technician to do the actual changing are even more widely known. Regarding FIG. 5, a user may wish to change a plain cover part 501 to another one 502 with more personal visual effects 503. According to the invention the user may have at his disposal one or more cover parts 504 that contain a rewritable notepad 102 together with the necessary erasing means 106 and a holder 505 for a writing instrument. Snap-on type mechanical fastening means 506 are preferably provided for making it easy and fast to attach a desired cover part to the portable telecommunications device in question.

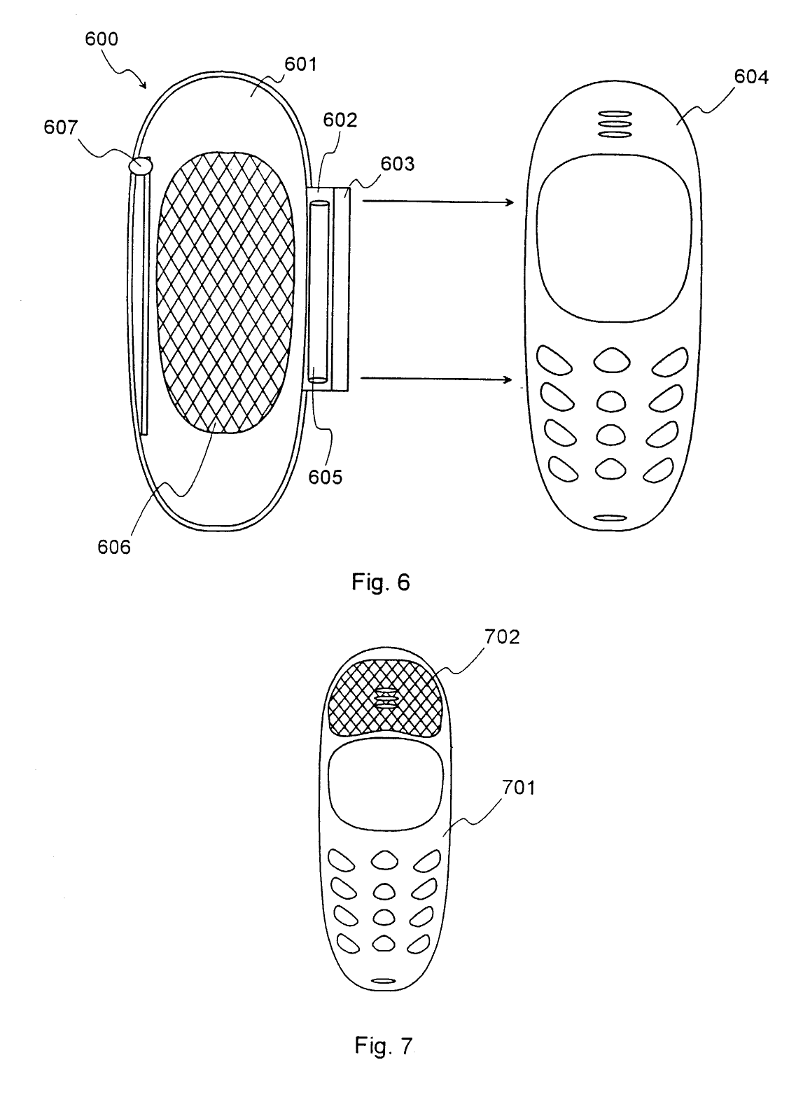

FIG. 6 illustrates schematically how the invention may be applied to produce an accessory that a user may add into an existing portable telecommunications device to reap the benefits of easy making of notes. The accessory 600 illustrated in FIG. 6 is a protective cover that comprises a flap part 601, a hinge part 602 and an attachment part 603. Of these the attachment part 603 is equipped with a sticky tape, a velcro-type fastening device, a glueing surface, mechanical fastening means or some other means for providing a semi-permanent attachment to a side surface of a portable telecommunications device 604. The hinge part 602 acts as a hinge that allows the flap part 601 to be turned into a position in which it covers and protects the user interface of the portable telecommunications device 604, once the accessory 600 has been attached to the side of the portable telecommunications device 604. Additionally in this embodiment of the invention the hinge part 602 comprises a holder 605 for a writing instrument. The flap part 601 comprises on at least one flat surface thereof a rewritable notepad 606 with its associated erasing means 607.

An accessory according to the invention does not need to be specifically of the type shown in FIG. 6. It is possible to provide a sheath-like accessory that constitutes a pocket for the portable electronic device and has on one side surface thereof a rewritable notepad. In a very simple accessory embodiment the accessory is simply a planar element like the flap part 601 of FIG. 6 alone with the rewritable notepad on one planar surface thereof. Such a simple accessory can be fastened e.g. to the back side of a mobile telephone by using glue or double-sided sticky tape on that surface of the accessory that does not comprise the rewritable notepad.

A rewritable notepad can be placed also to other parts of a mobile telephone type portable telecommunications device than back. FIG. 7 illustrates how a portable telecommunications device 701 may comprise a rewritable notepad 702 that is dimensioned to fit into a certain otherwise free space within the cover of the portable telecommunications device 701. In this case the rewritable notepad 702 fills the upper part of a front side of a mobile telephone 701. Holes are provided through the rewritable notepad 702 in order to let the voice emitted by the loudspeaker come through.

The invention requires the user of a conventional mobile telephone (complemented with notepad capability according to the invention) to take the mobile telephone from its normal operational position against the ear and place it in front of his face to be able to make notes. Additionally the invention typically requires the user to use both hands in making the notes, because one hand holds the notepad-equipped portable telecommunication device while the other moves the writing instrument. However, even this is a remarkable improvement over prior art, because the invention places few limitations to the nature and content of information to be written down while simultaneously ridding the user of the need for balancing the portable telecommunications device against his shoulder when making notes.

1. A portable telecommunications device comprising a rewritable notepad.

2. A portable telecommunications device according to claim 1, wherein said rewritable notepad is a magnetic migration display panel.

3. A portable telecommunications device according to claim 2, comprising:
an outer cover part,
a frame attached to said outer cover part,
a magnetic erasing bar supported within said frame and arranged to be movable between certain first and second extreme positions,
a cell plate attached to an outer side of said frame and extending over the area defined by the first and second extreme positions of said magnetic erasing bar, said cell plate having an inner structure of cells that contain magnetic particles embedded in an opaque dispersion.

4. A portable telecommunications device according to claim 2, comprising:
an outer cover part,
a magnetic erasing bar supported within said outer cover part and arranged to be movable between certain first and second extreme positions,
a cell plate attached to an outer side of said outer cover part and extending over the area defined by the first and second extreme positions of said magnetic erasing bar, said cell plate having an inner structure of cells that contain magnetic particles embedded in an opaque dispersion.

5. A portable telecommunications device according to claim 2, comprising:
an outer cover part,
a cell plate attached to an outer side of said outer cover part and extending over a certain area, said cell plate having an inner structure of cells that contain magnetic particles embedded in an opaque dispersion and
an array of controllable electromagnets essentially covering said certain area on an inner side of said cell plate.

6. A portable telecommunications device according to claim 1, comprising a holder for a writing instrument.

7. A portable telecommunications device according to claim 1, wherein said rewritable notepad is a chalkboard.

8. A portable telecommunications device according to claim 1, wherein said rewritable notepad is a whiteboard.

9. An exchangeable cover part for a portable telecommunications device, comprising a rewritable notepad.

10. An exchangeable cover part according to claim 9, comprising a holder for a writing instrument.

11. An accessory for a portable telecommunications device, the accessory comprising:
means for semi-permanently attaching the accessory to a portable telecommunications device and
a rewritable notepad.

12. An accessory according to claim 11, comprising:
a flap part that comprises said rewritable notepad, and
an attachment part for attaching said flap part to a portable telecommunications device.

13. An accessory according to claim 12, comprising a hinge part between said flap part and said attachment part, said hinge part being arranged to allow the flap part to be rotated around a longitudinal axis of said hinge part in order to change the position of the flap part in respect of a portable telecommunications device to which the attachment part is attached.

14. An accessory according to claim 13, comprising a holder within said hinge part for holding a writing instrument.
